(19) United States
(12) Patent Application Publication
(10) Pub. No.: US 2014/0342297 A1
(43) Pub. Date: Nov. 20, 2014

(54) Nozzle Device for a Furnace for Heat Treating a Steel Flat Product and Furnace Equipped with such a Nozzle Device

(71) Applicant: ThysseKrupp Steel Europe AG, Duisburg (DE)

(72) Inventors: Martin Norden, Mobil, AL (US); Marc Blumenau, Hagen (DE); Joachim Hulstrung, Dusseldorf (DE); Karsten Machalitza, Mulheim (DE); Rudolf Schoenenberg, Daphne, AL (US)

(21) Appl. No.: 14/365,922

(22) PCT Filed: Dec. 17, 2012
(86) PCT No.: PCT/EP2012/075770

§ 371 Date: Jun. 16, 2014

(30) Foreign Application Priority Data
Dec. 21, 2011 (DE) 10 2011 056 823.9

(51) Int. Cl. F27D 7/02; F27D 7/06

(52) U.S. Cl. CPC F27D 7/02; F27D 7/06; F27D 2007/063
USPC 432/198; 432/200

(57) ABSTRACT

A nozzle device for a furnace, having a central supply pipe, on which at least one nozzle opening and a feed connection for connecting the nozzle device to a gas supply are provided, the gas supply feeding a gas into the nozzle device flowing through the nozzle device and issuing from the at least one nozzle opening, and also relates to a furnace for heat treating a steel flat product. The nozzle device and the furnace by simple means ensure that the respective heat treatment produces uniform results in an optimum way. This is achieved by the nozzle device having a first section, in which it has a smaller effective nozzle opening cross-section than in a second section which seen in the flow direction of the gas issuing from the respective feed connection and flowing through the nozzle device is arranged further away from the feed connection in question.

The invention relates to a nozzle device for a furnace for heat treating a steel flat product. The nozzle device is designed in the style of a nozzle bar and comprises a central supply pipe, on which at least one nozzle opening and a feed connection for connecting the nozzle device to a gas supply are provided, the gas supply feeding a gas into the nozzle device flowing through the nozzle device and issuing from the at least one nozzle opening.

The invention also relates to a furnace for heat treating a steel flat product, wherein the furnace comprises at least one furnace zone which the steel flat product to be treated in each case passes through via a conveying path under a specifically composed zone atmosphere. A nozzle device is provided in the furnace zone and is connected via at least one feed connection to a gas supply which feeds a gas, which forms the zone atmosphere, into the nozzle device.

In automotive body construction, hot-rolled or cold-rolled steel flat products, such as steel strip or sheet, are used. Various demands are put on such steel flat products. On the one hand, they should be easily deformable and, on the other hand, they should have high strength. The high strength is obtained by adding certain alloying constituents, such as Mn, Si, Al and Cr, to iron. The steel flat products alloyed in such a way are provided with a metallic protective coating to prevent corrosion. Here, hot dip coating, in which the respective steel flat product in the pass slides through a melting bath and in the process is provided with a Zn or Al based coating, has proved a particularly cost-effective process for use on an industrial scale.

Possibilities for particularly effectively carrying out such a hot dip coating process in practice are, for example, described in EP 2 010 690 B1. The known methods have in common the fact that the steel flat product is subjected to a heat treatment before being dipped in the melting bath, in which its surface is brought to a condition which ensures optimum adhesion of the metallic coating applied during hot dip coating.

A variant of such a heat treatment makes provision for the strip which is to be coated to pass through a directly heated pre-heater (DFF=Direct Fired Furnace), in which an oxidation potential in the atmosphere surrounding the strip can be produced by means of the gas burners acting directly on the steel flat product. The increased oxygen potential leads to oxidation of the iron on the strip surface. In a subsequent furnace section, the iron oxide layer formed in this way is reduced. Since the thickness of the iron oxide layer is directly dependent on the period of time which the steel flat product has been exposed to the oxidising atmosphere, setting the oxide layer thickness on the strip surface in a targeted way is in practice difficult. As a result of a layer thickness which cannot be precisely set easily, the difficulty of guaranteeing a distinctly defined strip surface quality arises during subsequent reduction of the oxide layer under a reducing atmosphere. An unfavourable surface quality can, however, in turn lead to adhesion problems for the coating on the strip surface.

In modern hot dip coating lines with an RTF pre-heater (RTF=Radiant Tube Furnace) different from DFF type furnaces no gas-heated open burners are used. Instead, in RTF installations the complete annealing treatment of the strip takes place under a protective gas atmosphere. However, with such an annealing treatment of a steel strip having higher alloying constituents, these alloying constituents can diffuse on the strip surface and form irreducible oxides. These oxides prevent the strip surface from being coated with zinc and/or aluminium in the melting bath without flaws.

A process for continuous hot dip coating of a steel strip with aluminium is known from DE 689 12 243 T2, in which the strip is heated in a continuous furnace. Surface impurities are removed in a first zone. The furnace atmosphere has a very high temperature for this. However, since the strip passes through this zone at high speed, it is only heated to about half of the temperature of the atmosphere. In the subsequent second zone, under a protective gas, the strip is heated to the temperature of the coating material aluminium.

In addition, a two-stage hot dip coating process for a steel alloy strip containing chrome is known from DE 695 07 977 T2. According to this process, the strip is annealed in a first stage, in order to obtain an iron enrichment on the strip surface. Afterwards, the strip is heated to the temperature of the coating metal in a non-oxidising atmosphere.

It is also known from JP 02285057 A to galvanise a steel strip in a multi-stage process. For this purpose, the previously cleaned strip is treated in a non-oxidising atmosphere at a temperature of about 820° C. Then, the strip is treated at about 400° C. to 700° C. in a weakly oxidising atmosphere before it is reduced on its surface in a reducing atmosphere. Subsequently, the strip cooled down to about 420° C. to 500° C. is galvanised in the usual way.

Finally, a process for heat treating a steel flat product in a continuous furnace is known from US 2010/0173072 A1, in which the steel flat product to be treated in each case is exposed to an oxidising gas atmosphere which is blown into the respective furnace zone by means of radiant tubes or dosing tubes provided with bored holes.

In the case of the radiant tube variant described in US 2010/0173072 A1, a combustion gas flows into the radiant tube, to which a gas or gas mixture regulating the furnace atmosphere or its dew point is added. Carbon monoxide or carbon dioxide can penetrate into the furnace chamber through the bored holes in the radiant tube in addition to the gases which act in an oxidising way, which can lead to carburisation of the material and hence to a change in the material properties. In addition, with this variant the atmosphere must be designed dependent on the furnace load because the temperature of the furnace chamber and heating the material through, i.e. a process dependent on the thickness, are regulated via the combustion gas.

In the case of the dosing tube variant also known from US 2010/0173072 A1, in contrast, a nozzle device consisting of a holed or slit tube is used which is connected to a gas supply which feeds in a carbon-free gas mixture. This variant avoids the disadvantages of introducing combustion gases into the furnace atmosphere but has the disadvantage in practice that the homogeneity of the annealing gas-metal reaction in the respective furnace zone is insufficient. This applies not only with respect to the distribution of the oxidation medium over the width of the steel flat product but also with respect to the distribution of the oxidation medium within the respective furnace zones. Thus, in the direct vicinity of the nozzle device an overly strong oxidation can occur, whilst in an area further away the oxidation potential is too low. Despite its basic advantages, coating flaws therefore also arise when using a nozzle device of the type known from US 2010/0173072 A1.

Against this background of the previously explained prior art, the object of the invention entailed producing by simple means a nozzle device and a furnace provided with such a nozzle device, with which optimally uniform results for the respective heat treatment can be guaranteed.

With respect to the nozzle device, this object is achieved according to the invention by the nozzle device having the features specified in claim 1.

With respect to the heat treatment furnace, the previously mentioned object of the invention is, on the other hand, achieved by such a furnace having the features mentioned in claim 12.

Advantageous embodiments of the invention are specified in the dependent claims and are explained below along with the general concept of the invention.

A nozzle device according to the invention for a furnace for heat treating a steel flat product is equipped with a central supply pipe, on which at least one nozzle opening and a feed connection for connecting the nozzle device to a gas supply are provided, the gas supply feeding a gas into the nozzle device flowing through the nozzle device and issuing from the at least one nozzle opening.

A nozzle device according to the invention at the same time has a first section, in which it has a smaller effective nozzle opening cross-section than in a second section which seen in the flow direction of the gas issuing from the respective feed connection and flowing through the nozzle device is arranged further away from the feed connection in question.

The embodiment of a nozzle device according to the invention takes into account the fact that the pressure of the gas admitted into the nozzle device drops at increasing distance from the feed connection. According to the invention, this drop in pressure is compensated for by the outlet cross-section area of the at least one nozzle opening of the nozzle device increasing at increasing distance from the assigned feed connection. In an optimum way, the enlargement in the nozzle openings occurs directly proportionally to the drop in pressure in the pipe conveying gas and supplying the nozzle openings of the nozzle device.

A constantly sufficient supply to the respectively present nozzle openings of a nozzle device according to the invention can, with a respectively sufficiently high impulse of the gas jets issuing from the respectively present nozzle openings, be ensured by the sum of the opening areas of all nozzle openings being less than or equal to the half cross-section of the supply pipe.

The design of the dosing tube geometry according to the invention improves the homogeneity of feeding in the oxidative medium considerably by optimising the inflow into the furnace zone. This applies both in relation to the steel strip width and for the distribution of the oxidative medium within the respective furnace zone. This again reduces coating defects and increases process robustness.

When gas is mentioned in this text, by that all pure gases and all gas mixtures are meant which are suitable for achieving the purpose intended with the heat treatment under the zone atmosphere. In practice, these can be gases which behave inertly in relation to the steel flat product to be handled in each case or they can be gases which cause a certain reaction on the surface of the steel flat product at the respectively prevailing temperatures in the furnace zone. Among the gases typically used in practice are gas mixtures acting in a reducing way in relation to certain alloying elements of the steel flat product, e.g. nitrogen-hydrogen mixtures, gas mixtures which are to bring about an oxidation of the surface of the steel product, such as N₂—H₂—O₂ gas mixtures, or nitrogen on its own if the steel flat product is to be shielded with respect to reactive gases in the ambient atmosphere during heat treatment.

A nozzle device according to the invention has at least one nozzle opening, via which a gas jet in each case is blown into the zone of the furnace assigned to the nozzle device. If the nozzle device has a nozzle opening which extends in the longitudinal direction of the nozzle device at least over a predominant part of the length of the supply pipe, this nozzle opening is advantageously slit-shaped and is also aligned transverse to the conveying path. At the same time, the nozzle opening in question also in this case has at least two sections arranged adjacent to one another, of which the section of the nozzle device, which seen in the flow direction of the gas flowing through the nozzle device is arranged closer to the assigned feed connection, has a smaller effective nozzle cross-section than the section of the nozzle device which is arranged further away from the feed connection in question.

Of course, with the above explained variant of the invention, it is possible for the effective opening cross-section of the nozzle opening formed as a slit nozzle to be continuously widened seen in the flow direction of the gas flowing through the supply pipe. In the case of such a continuously increasing widening of the effective opening cross-section, the slit-shaped nozzle opening therefore has an unlimited number of adjacent sections, of which the section respectively further away in the flow direction of the gas has a larger opening cross-section than the section arranged closer to the feed connection.

According to another variant of the invention, the nozzle device in each case has more than one nozzle opening, wherein seen in the flow direction of the gas flowing through the nozzle device there are at least two sections arranged adjacent to one another, of which in the case of the section of the nozzle device respectively arranged closer to the assigned feed connection the effective nozzle opening cross-section of the at least one nozzle opening respectively present there is smaller than the effective nozzle opening cross-section of the at least one nozzle opening which is present in that section of the nozzle device which is arranged further away from the feed connection in question.

Optimum uniformity of the gas jets flowing out of the nozzle openings can be obtained by steadily increasing the opening diameter from nozzle opening to nozzle opening in the flow direction of the gas, so that nozzle openings arranged adjacent to one another always have different opening diameters.

In practice, the production time and effort associated with such a continuous increase in the opening cross-sections of the nozzle openings can be reduced by providing a plurality of nozzle openings but by also obviously assigning to each section of the nozzle device two or more nozzle openings with the same cross-section combined into one group. In this case, each nozzle opening does not differ from the respectively most adjacent nozzle opening with respect to the size of its opening cross-section. Instead, only that nozzle opening, which is assigned to a boundary of the respective section, has a different opening cross-section size than the nozzle opening, which is assigned to the same boundary, of the abutting other section.

Correspondingly, a further embodiment of the invention, which is important in practice, makes provision that, in the case in which there are a plurality of nozzle openings, the nozzle openings are arranged side by side distributed in the longitudinal direction of the nozzle device, and that the nozzle opening, which is located in the section of the nozzle device which seen in the flow direction of the gas flowing through the nozzle device is arranged closer to the assigned feed connection, is smaller than the nozzle opening which is located in the section of the nozzle device arranged further away from the feed connection in question.

The uniformity with regard to spatial distribution and with regard to the gas volume flow issuing per section of the nozzle device can also be supported by the nozzle openings being arranged side by side distributed in the longitudinal direction of the nozzle device and seen in the flow direction of the gas flowing through the nozzle device by the gap between adjacent nozzle openings becoming smaller at increasing distance from the assigned feed connection. In this case, the nozzle openings in the sections of the nozzle device further away from the feed connection are on average arranged more closely than in the sections more closely adjacent to the feed connection.

Assuming that the opening cross-sections of the nozzle openings are identical or increase at increasing distance from the assigned feed connection, an increasing opening cross-section therefore results in total per section of the nozzle device. If sections are assumed whose length of the sections of the nozzle device measured in the flow direction of the gas flowing through the nozzle device is the same, then, particularly if the nozzle openings in each case have an identical opening cross-section size, in the section of the nozzle device, which seen in the flow direction of the gas flowing through the nozzle device is arranged closer to the assigned feed connection, there are fewer nozzle openings than in the section of the nozzle device which is further away from the feed connection in question. The advantage of this embodiment is that the nozzle device according to the invention can be produced particularly easily. This particularly applies if the nozzle openings are formed by identical, separately prefabricated nozzle inserts.

If specifically determined gas flows are to be effected in the furnace chamber or, taking account of the respective structural conditions, flow obstructions are to be compensated for, then for this purpose in at least two adjacent sections of the nozzle device the gas jets discharged in the area of the one section can be aligned differently than the gas jets discharged in the adjacent section. By aligning the nozzle openings accordingly, a main flow and a sub-flow, for example, can be produced, the main flow assuming the role of covering the product conveyed through the furnace, whilst the sub-flow can be used as a blocking flow to protect the respective furnace zone from permeation by an external atmosphere.

A further improvement in the distribution of the gas jets issuing from the nozzle device according to the invention within the respective zone of the furnace can also be brought about by arranging the nozzle openings in at least one section of the nozzle device in two or more rows which extend seen in the flow direction of the gas flowing through the nozzle device. At the same time, different gas jets and an optimum spatial distribution of the gas jets can be obtained by aligning the gas jets issuing from the nozzle openings of the one row differently than the gas jets which issue from the nozzle openings of the other row.

The feed connection of a nozzle device according to the invention is in each case arranged in such a way that the gas flowing in is distributed as uniformly as possible in the supply pipe of the nozzle device. According to a first embodiment, for this purpose the feed connection is arranged centrally in relation to the length of the supply pipe. The gas flowing into the supply pipe is then distributed automatically almost in equal parts to both areas of the supply pipe going away laterally from the middle, so that a uniform distribution of the gas is guaranteed with little effort.

Alternatively or additionally, it is also possible to supply the gas via a feed connection which is arranged at one of the ends of the supply pipe. All nozzle openings of the nozzle device can be uniformly supplied in an optimum way by providing a separate feed connection at each end of the supply pipe. In this case, gas flows from each end of the supply pipe into the nozzle device, so that gas flows directed against each other are present within the supply pipe and meet approximately in the middle of the pipe. In this way, the nozzle openings arranged in the middle of the supply pipe, and in the case of this embodiment furthest away from the feed connections, are also reliably supplied with a sufficient amount of gas.

A high kinetic energy and as a consequence particularly good intermixing of the gas jets respectively discharged via the nozzle device with the atmosphere prevailing in the respective furnace zone can be achieved by the nozzle openings seen in cross-section in each case starting from the interior of the supply pipe narrowing conically in the direction of its outer surface. The gas flow flowing through the nozzle openings in each case is accelerated by the constriction and enters the atmosphere in the respective furnace zone as a concentrated gas jet with high impulse, thoroughly mixing with this atmosphere as a result of its own flow energy. At the same time, the impulse of the gas jet benefits from the nozzle channel having a large cross-section in its inlet opening area, which reduces flow losses when the gas flows into the nozzle.

A furnace according to the invention for heat treating a steel flat product comprises at least one furnace zone which the steel flat product to be treated in each case passes through in a conveying path under a specifically composed zone atmosphere, wherein a nozzle device designed according to the invention and arranged transverse to the conveying path of the steel flat product is provided in the furnace zone and is connected via at least one feed connection to a gas supply which feeds a gas, which forms the zone atmosphere, into the nozzle device. The furnace according to the invention is typically an RTF-type furnace which is indirectly heated.

The furnace atmosphere and its dew point can be particularly precisely set by the gas supply to the furnace comprising a mixing device for pre-mixing and optionally moistening the gas.

Nozzle devices designed according to the invention can be particularly advantageously utilised in furnaces which comprise a plurality of furnace zones adjoining one another which the steel flat product to be treated in each case successively passes through, wherein at least one nozzle device designed according to the invention is in each case assigned to each furnace zone. At the same time, the nozzles devices, as already explained above, can be designed in such a way that that they produce a main flow and at least one sub-flow which is used as a blocking flow to seal the respective furnace zone off from permeation by an external atmosphere.

The nozzle device according to the invention is to a special degree suitable for use in an indirectly heated continuous furnace, in which a steel flat product is heat treated which in a continuous sequence passes through a heating-up zone, in which the steel flat product under a heating-up atmosphere is heated up to a target temperature lying within a target temperature range, and a holding zone, in which the steel flat product under a holding atmosphere is held at a holding temperature lying within the target temperature range, wherein to maintain the heating-up atmosphere and the holding atmosphere a gas mixture flow in each case is directed into the heating-up zone and the holding zone in each case via at least one nozzle device according to the invention.

The invention is explained in more detail below by means of exemplary embodiments. All figures are shown schematically and not to scale.

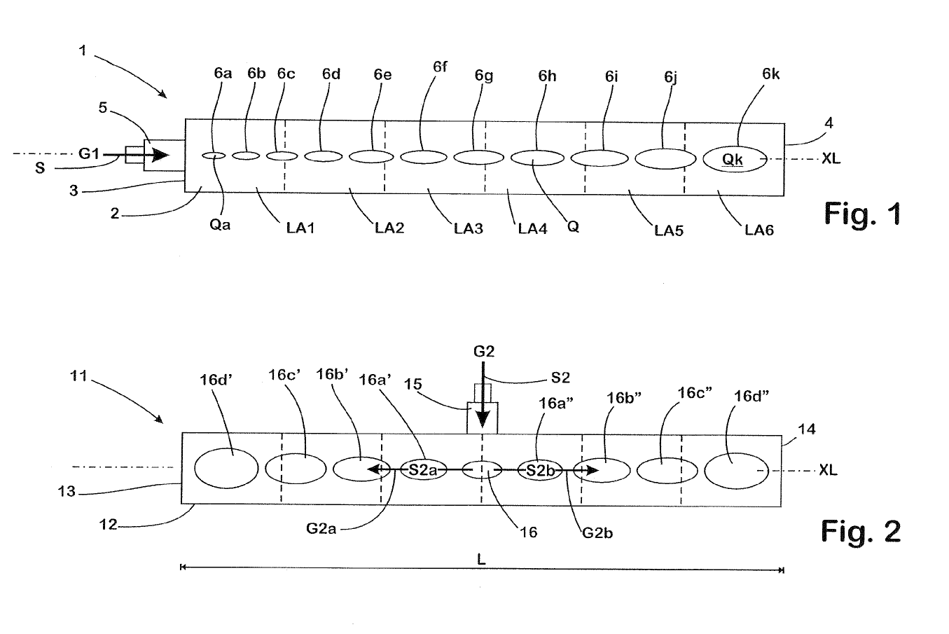

FIG. 1 shows a first nozzle device in a lateral view;

FIG. 2 shows a second nozzle device in a lateral view;

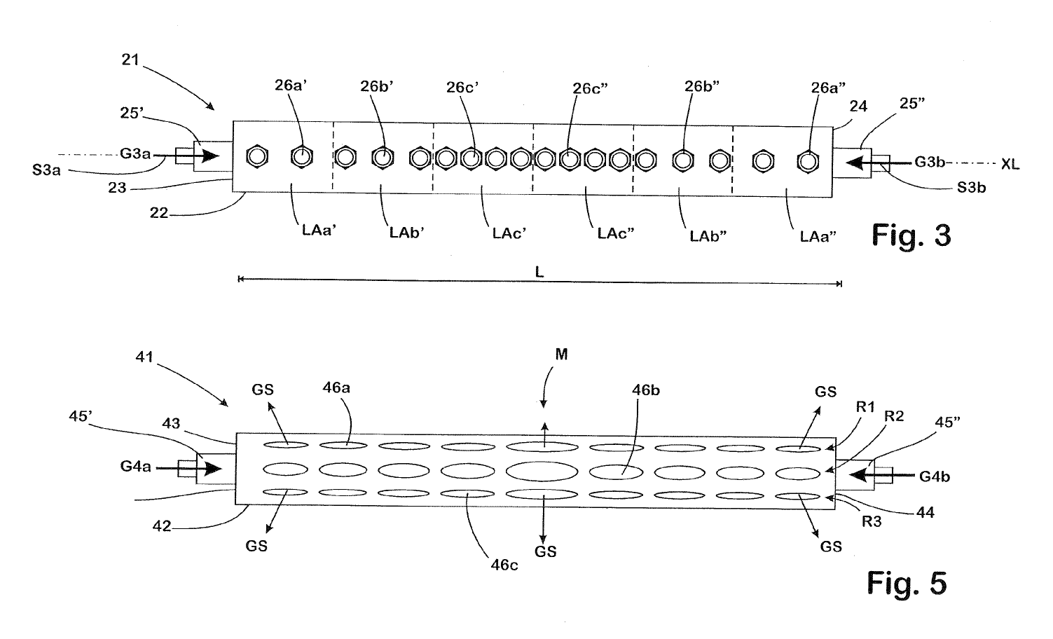

FIG. 3 shows a third nozzle device in a lateral view;

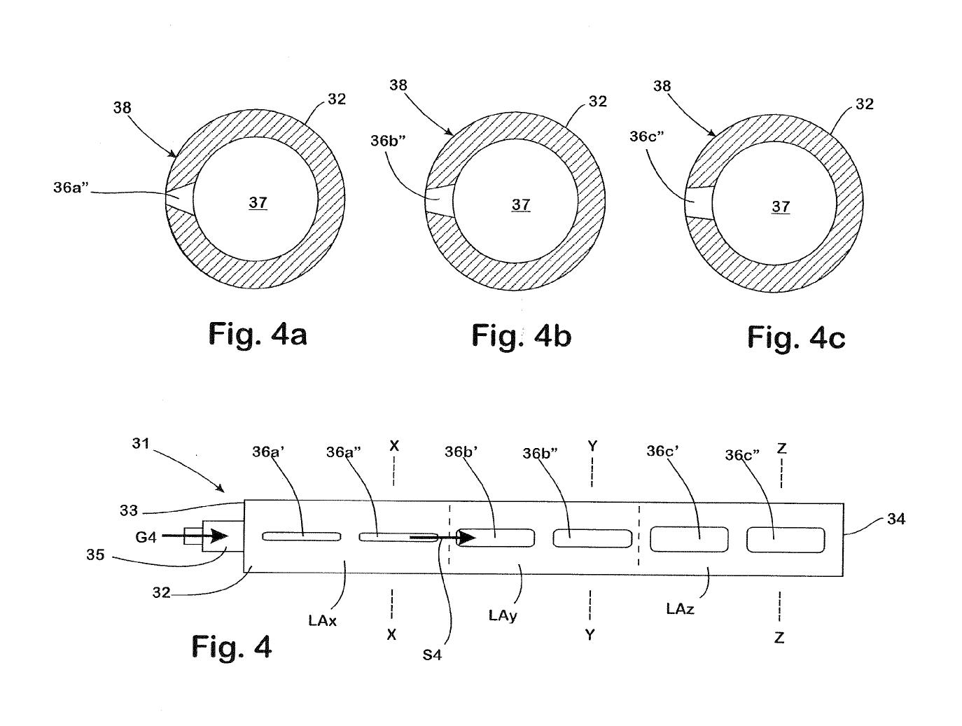

FIG. 4 shows a fourth nozzle device in a lateral view;

FIG. 4a shows the nozzle device according to FIG. 4 in a section along the intersection line X-X delineated in FIG. 4;

FIG. 4b shows the nozzle device according to FIG. 4 in a section along the intersection line Y-Y delineated in FIG. 4;

FIG. 4c shows the nozzle device according to FIG. 4 in a section along the intersection line Z-Z delineated in FIG. 4;

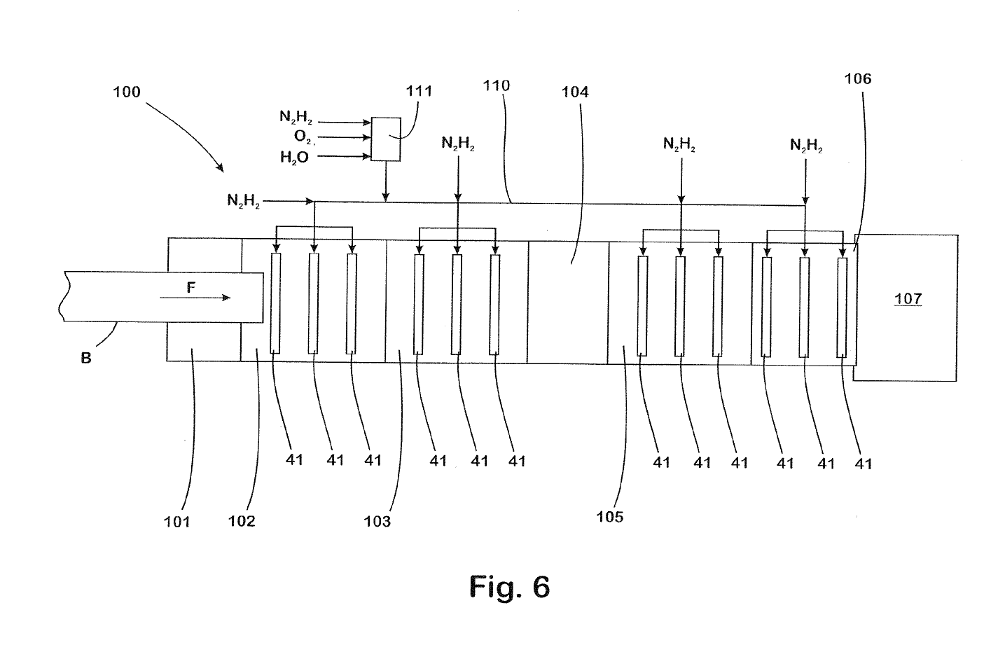

FIG. 5 shows a fifth nozzle device in a lateral view;

FIG. 6 shows a diagram of a continuous furnace for heat treating a steel strip.

The nozzle device 1 illustrated in FIG. 1 and designed in the style of a nozzle bar comprises a central supply pipe 2 which has a circular cross-section and is closed tight on its one front end 3, whilst a feed connection 5 is arranged on its opposite front end 4, via which a gas flow G1 is directed into the supply pipe 2.

Nozzle openings 6a-6k arranged side by side are formed into the supply pipe 2 in the flow direction S of the gas flow G1 flowing in the supply pipe 2, the opening centre points of which nozzle openings 6a-6k lie on a line aligned coaxially to the longitudinal axis XL of the supply pipe 2. The nozzle openings 6a-6k are each positioned spaced apart from one another at equal distances but each have different opening cross-sections Q increasing gradually in the flow direction S. Thus, the nozzle opening 6a positioned most adjacent to the feed connection 5 has the smallest opening cross-section Qa, whilst the nozzle opening 6k furthest away from the feed connection 5 in the flow direction S has the largest opening cross-section Qk and each of the nozzle openings 6a-6j has a smaller opening cross-section than the respectively most adjacent nozzle opening 6b-6k in the flow direction S. As a result, the sum of the effective opening cross-sections Qa-Qk of the nozzle openings 6a-6k respectively allocated to longitudinal sections LA1-LA6 of equal length of the supply pipe starting from the longitudinal section LA1-LA6 assigned to the feed connection 5 can be increased in the flow direction S from longitudinal section LA1-LA5 to longitudinal section LA2-LA6.

The nozzle device 11 illustrated in FIG. 2, which is likewise designed in the style of a nozzle bar, also comprises a central supply pipe 12 which is circular in cross-section and which here, however, is closed on both of its front ends 13, 14. A central feed connection 15 is provided on the supply pipe 12, which is aligned centrally in relation to the length L of the supply pipe 12 and via which a gas flow G2 flows into the supply pipe 12 in a flow direction S2 aligned perpendicular to the longitudinal axis XL of the supply pipe 12. The gas flow G2 divides into gas partial flows G2a, G2b of approximately the same size on the wall of the supply pipe 12 opposite the feed connection 15, the one of which gas partial flows G2a, G2b flows in a flow direction S2a aligned coaxially to the longitudinal axis XL in the direction of the one front end 13 and the other flows in an opposite flow direction S2b likewise aligned coaxially to the longitudinal axis XL in the direction of the other front end 14 of the supply pipe 12.

Nozzle openings 16, 16a′-16d′, 16a″-16d″ are formed side by side into the supply pipe 12, the opening centre points of which also lie on a line aligned coaxially to the longitudinal axis XL of the supply pipe 12. The nozzle openings 16, 16a′-16d′, 16a″-16d″ are also each positioned spaced apart from one another at equal distances but each have different opening cross-sections increasing gradually starting from the centrally arranged nozzle opening 16 in the respective flow direction S2a, S2b of the gas partial flows G2a, G2b flowing through the supply pipe 12. In this way, the nozzle openings 16a′, 16a″ each arranged laterally from the central nozzle opening 16 have a larger opening cross-section than the central nozzle opening 16, whilst the nozzle openings 16b′, 16b″ respectively arranged most adjacent to the nozzle openings 16a′, 16a″ in the respective flow direction S2a, S2b in turn have a larger nozzle opening cross-section than the nozzle openings 16a′, 16a″ and so on and so forth. The nozzle openings 16d′, 16d″ each lying on the outside, directly adjacent to the respective front end 13, 14 and furthest away from the feed connection 15 correspondingly have the largest opening cross-section.

The nozzle device 21 illustrated in FIG. 3, which is likewise designed in the style of a nozzle bar, also comprises a central supply pipe 22 which is circular in cross-section. However, in this embodiment, a feed connection 25′, 25″ is provided on each of the front ends 23, 24, via which in each case a gas flow G3a, G3b flows into the supply pipe 22 in a flow direction S3a, S3b aligned coaxially to the longitudinal axis XL of the supply pipe 22. The gas flows G3a, G3b are correspondingly directed against each another and meet in the middle M of the supply pipe 22.

Nozzle openings 26a′-26c′, 26a″-26c″ are provided which are formed by nozzle inserts placed into corresponding slots in the supply pipe 22. The nozzle openings 26a′-26c′, 26a″-26c″ in each case have identical opening cross-sections. However, the number of nozzle openings 26a′-26c′, 26a″-26c″ provided per longitudinal section LAa′-LAc″ increases in the direction of the middle of the supply pipe 22 starting from the longitudinal section LAa′, LAa″ respectively assigned to one of the feed connections 25′, 25″. Correspondingly, the longitudinal sections LAc′, LAc″ abutting-on one another in the middle of the supply pipe 22 in relation to the length L in each case have four nozzle openings 26c′, 26c″, whilst in the longitudinal sections LAb′, LAb″ which are most adjacent in the direction of the respectively assigned feed connection 25′, 25″ in each case only three nozzle openings 26c′, 26c″ are provided and so on and so forth. The longitudinal section LAa′, LAa″ directly abutting on the feed connection 25′, 25″ consequently has the fewest nozzle openings 26a′, 26a″ and therefore also the smallest effective opening cross-section, whilst the longitudinal sections LAc′, LAc″ arranged in the middle of the supply pipe 22 and furthest away from the respective feed connection 25′, 25″ have the most nozzle openings 26c′, 26c″ and therefore also the largest effective nozzle opening cross-section.

In the exemplary embodiment illustrated in FIG. 4, the nozzle device 31 likewise has a supply pipe 32 with a circular cross-section and a single feed connection 35 which like with the nozzle device 1 is arranged on the one front end 33 of the supply pipe 32. In contrast, the other front end 34 of the supply pipe 32 is closed.

The supply pipe 32 is in this case sub-divided into three longitudinal sections LAx, LAy, LAz of equal length, to which in each case two slit-shaped nozzle openings 36a′, 36a″, 36b′, 36b″, 36c′, 36c″ are assigned. The opening cross-sections of the nozzle openings 36a′, 36a″ of the longitudinal section LAx most adjacent to the feed connection 35 are smaller than the opening cross-sections of the nozzle openings 36b′, 36b″ of the longitudinal section LAy adjacent in the flow direction S4 of the gas flow G4 flowing through the supply pipe 32 and located in the middle of the length L of the supply pipe 32. The opening cross-sections of the nozzle openings 36b′, 36b″ of the longitudinal section LAy are similarly smaller than the opening cross-sections of the nozzle openings 36c′, 36c″ of the longitudinal section LAz furthest away from the feed connection 35 in the flow direction S4.

Seen in cross-section the nozzle openings 36a′-36c″ in each case starting from the interior 37 of the supply pipe 32 narrow conically in the direction of its outer surface 38, so that the gas flow flowing through the nozzle openings 36a′-36c″ in each case is accelerated and enters the atmosphere in the respective furnace zone as a concentrated gas jet with high impulse. The high kinetic energy with which the gas jets enter the surrounding area ensures particularly good intermixing of the atmosphere prevailing in the respective furnace zone.

The nozzle device 41 illustrated in FIG. 5 corresponds in its basic design to the nozzle device 31, but has three rows R1, R2, R3 of nozzle openings 46a, 46b, 46c arranged axially parallel to one another and on its front ends 43, 44 a feed connection 45a, 45b respectively, via which the nozzle openings 46a, 46b, 46c are supplied with a gas flow G4a, G4b. The opening cross-sections of the nozzle openings 46a, 46b, 46c formed into the supply pipe 42 of the nozzle device 41 increase gradually in the direction of the middle of the supply pipe 42 starting from the respective feed connection 45a, 45b, so that the nozzle opening with the smallest opening cross-section in each case is located most adjacent to the respectively assigned feed connection, whilst the nozzle opening with the largest opening cross-section in each of the rows R1-R3 is arranged centrally in the middle M of the length L of the supply pipe 42.

The nozzle openings 46a, 46b, 46c assigned to the individual rows R1, R2, R3 can each be aligned in different directions, so that the gas jets GS issuing from the nozzle openings 46a, 46b, 46c are distributed in different spatial directions.

A continuous furnace 100 schematically illustrated in FIG. 6 for heat treating a steel strip B conveyed through the continuous furnace 100 in the conveying direction F, typically comprises a pre-heating zone 101, in which the steel strip B is pre-heated to a pre-heating temperature for example under a normal atmosphere, a heating-up zone 102, in which the steel strip B is heated up to a heating-up temperature under an N₂—H₂-containing atmosphere, a holding zone 103, in which the steel strip B is held at the heating-up temperature under an N₂—H₂-containing atmosphere or if required further heated, a cooling zone 104, in which the steel strip B is cooled down to a melting bath immersion temperature, and an equalisation and overageing zone, in which the steel strip B is held at the melting bath immersion temperature under an N₂—H₂-containing atmosphere.

From the equalisation and overageing zone 105, the steel strip B sealed off in relation to the ambient atmosphere is directed into a melting bath 107 via a discharge chute 106, in which it is provided with a metallic coating which protects against corrosion.

In order to maintain the N₂—H₂-containing atmosphere, nozzle devices 41 of the type illustrated in FIG. 5 are for example arranged in the heating-up zone 102, the holding zone 103 and the equalisation and overageing zone 105 and the discharge chute 106 in each case. The nozzle devices 41 are connected to a central gas supply 110 which conveys dry N₂—H₂ gas.

In order to be able to regulate the dew point and the oxidation potential of the atmosphere prevailing in the heating-up zone 102 and the holding zone 103 in each case, a pre-mixing device 111 connected to the nozzle devices 41 assigned to these zones 102, 103 is provided, via which an N₂—H₂ gas mixture mixed with H₂O and/or O₂ can be formed.

| Reference symbol | Element |
|---|---|
| 1 | Nozzle device |
| 2 | Supply pipe |
| 3 | Front end of supply pipe 2 |
| 4 | Front end of supply pipe 2 |
| 5 | Feed connection |
| 6a-6k | Nozzle openings |
| G1 | Gas flow |
| LA1-LA6 | Longitudinal sections of |
| | supply pipe 2 |
| Q | Opening cross-sections of |
| | nozzle openings 6b-6j |
| Qa | Opening cross-section of |
| | nozzle opening 6a |
| Qk | Opening cross-section of |
| | nozzle opening 6k |
| S | Flow direction |
| 11 | Nozzle device |
| 12 | Supply pipe |
| 13, 14 | Front ends of supply pipe 12 |
| 15 | Feed connection |
| 16-16d″ | Nozzle openings |
| G2 | Gas flow |
| G2a, G2b | Gas partial flows |
| S2, S2a, S2b | Flow directions |
| 21 | Nozzle device |
| 22 | Supply pipe |
| 23, 24 | Front ends of supply pipe 22 |
| 26a′-26c″ | Nozzle openings |
| 25′-25″ | Feed connections |
| G3a, G3b | Gas flows |
| LAa′-LAc″ | Longitudinal sections |
| S3a, S3b | Flow direction |
| 31 | Nozzle device |
| 32 | Supply pipe |
| 35 | Feed connection |
| 33, 34 | Front end of supply pipe 32 |
| 36a′-36c″ | Nozzle openings |
| G4 | Gas flow |
| Lax-LAz | Longitudinal sections |
| S4 | Flow direction |
| 37 | Interior of supply pipe 32 |
| 38 | Outer surface of supply pipe |
| | 32 |
| 41 | Nozzle device |
| 42 | Supply pipe of nozzle device |
| | 41 |
| 43, 44 | Front ends of supply pipe 42 |
| 45′, 45″ | Feed connections |
| 46a-46c | Nozzle openings |
| G4a, G4b | Gas flows |
| GS | Gas jets |
| R1-R3 | Rows of nozzle openings |
| 100 | Continuous furnace |
| 101 | Pre-heating zone |
| 102 | Heating-up zone |
| 103 | Holding zone |
| 104 | Cooling zone |
| 105 | Equalisation and overageing |
| | zone |
| 106 | Discharge chute |
| 107 | Melting bath |
| 110 | Gas supply |
| 111 | Pre-mixing device |
| F | Conveying direction |
| B | Steel strip |
| L | Length of the supply pipes |
| | 2, 12, 22, 32, 42 |
| XL | Longitudinal axis of the |
| | supply pipes 2, 12, 22, 32, |
| | 42 |
| M | Middle of the length L of |
| | the supply pipes 2, 12, 22, |
| | 32, 42 |

1-18. (canceled)

19. A nozzle device comprising:
a central supply pipe having at least one nozzle opening and a feed connection for connecting the nozzle device to a gas supply,
wherein the gas supply feeds a gas into the nozzle device, the gas flows through the nozzle device in a flow direction, and issues from the at least one nozzle opening,
wherein the nozzle device has a first section and a second section along the flow direction of the gas, the second section being located further from the feed connection than the first section, and
wherein nozzles in the first section have a smaller effective nozzle opening cross section than nozzles in the second section.

20. The nozzle device according to claim 19, wherein the sum of the effective opening cross-sections of all nozzle openings is less than or equal to a half cross-section of the central supply pipe.

21. The nozzle device according to claim 19, wherein the nozzle device has a nozzle opening which extends in the longitudinal direction of the nozzle device over at least a predominant part of the length of the central supply pipe such that that the nozzle opening is slit-shaped and is also aligned transverse to a conveying path, and in that the nozzle opening has at least two sections arranged adjacent to one another, of which the section of the nozzle device, which seen in the flow direction of the gas flowing through the nozzle device is arranged closer to the assigned feed connection, has a smaller effective nozzle cross-section than the section of the nozzle device which is arranged further away from the feed connection.

22. The nozzle device according to claim 19, wherein the nozzle device has more than one nozzle opening, and at least two sections adjacent to one another along the flow direction of the gas, wherein at least one of the nozzle openings in the section closer to the assigned feed connection has a smaller effective nozzle opening cross-section than at least one nozzle opening in the section further from the assigned feed connection.

23. The nozzle device according to claim 22, wherein the nozzle openings are arranged side by side and distributed in the longitudinal direction of the nozzle device, and in that the nozzle opening which is located in the section of the nozzle device which, seen in the flow direction of the gas flowing through the nozzle device, is arranged closer to the assigned feed connection, is smaller than the nozzle opening which is located in the section) of the nozzle device arranged further away from the assigned feed connection.

24. The nozzle device according to claim 22, wherein the nozzle openings are arranged side by side and distributed in the longitudinal direction of the nozzle device, wherein the gap between adjacent nozzle openings becomes smaller as the distance from the assigned feed connection increases.

25. The nozzle device according to claim 22, wherein the sections of the nozzle device are the same length where the sections closer to the feed connection contain fewer nozzle openings than in the sections further from the feed connection.

26. The nozzle device according to claim 25, wherein the nozzle openings provided in the sections of the nozzle device are the same size.

27. The nozzle device according to claim 22, wherein in the case of at least two adjacent sections of the nozzle device, gas jets discharged in the area of the one section are aligned differently than gas jets discharged in the adjacent section.

28. The nozzle device according to claim 22, wherein the nozzle openings in at least one section of the nozzle device are arranged in at least two rows which extend in the flow direction of the gas flowing through the nozzle device.

29. The nozzle device according to claim 28, wherein gas jets which issue from the nozzle openings of the one row are aligned differently than gas jets which issue from the nozzle openings of the other row.

30. The nozzle device according to claim 19, wherein the feed connection is arranged centrally in relation to the length of the central supply pipe.

31. The nozzle device according to claim 19, wherein a feed connection is arranged at each end of the central supply pipe.

32. The nozzle device according to claim 19, wherein the nozzle openings seen in cross-section in each case starting from the interior of the supply pipe narrow conically in the direction of its outer surface.

33. A furnace comprising at least one furnace zone which a steel flat product to be treated passes through in a conveying path under a specifically composed zone atmosphere, wherein a nozzle device is provided in the furnace zone and is connected via at least one feed connection to a gas supply which feeds a gas, which forms the zone atmosphere, into the nozzle device, wherein the nozzle device is designed according to claim 1 and is arranged transverse to the conveying path of the steel flat product in the furnace.

34. The furnace according to claim 33, wherein the furnace is indirectly heated.

35. The furnace according to claim 33, wherein the gas supply comprises a mixing device for pre-mixing and optionally moistening the gas.

36. The furnace according to claim 33, wherein the furnace comprises a plurality of furnace zones adjoining one another, which the steel flat product to be treated in each case successively passes through, and to which furnace zones in each case at least one nozzle device designed according to claim 1 is assigned.

37. The nozzle device of claim 19 wherein the nozzle device is designed for a furnace for heat treating a steel flat product.

38. The furnace according to claim 33, wherein the furnace is for heat treating a steel flat product.
